(19) United States
(12) Patent Application Publication
(10) Pub. No.: US 2024/0147955 A1
(43) Pub. Date: May 9, 2024

(54) PET TOILET

(71) Applicant: Ben STAR, Cobble Hill (CA)

(72) Inventor: Ben STAR, Cobble Hill (CA)

(21) Appl. No.: 18/280,636

(22) PCT Filed: Mar. 2, 2022
(86) PCT No.: PCT/CA22/50294

§ 371 Date: Sep. 6, 2023

(30) Foreign Application Priority Data
Mar. 9, 2021 (CA) 3111547

(51) Int. Cl. A01K 1/01

(52) U.S. Cl. CPC A01K 1/011

(57) ABSTRACT

A pet toilet includes a water retaining tray having an outlet for connecting the tray to household plumbing. A continuous shelf on which a pet stands during use is contained within the tray. The shelf is spaced above a bottom of the tray and angled with an upper end and a lower end. A flushing system causes a release of water onto the upper end of the shelf. The release of water washes faeces down the shelf and off the lower end of the shelf into the tray, with the faeces exiting the tray through the outlet. As male dogs tend to raise their leg to urinate, it is preferred that the pet toilet have opposed sidewalls and a supplementary release of water be provided to wash down the opposed sidewalls.

### FIELD

There is described a toilet that was designed for use by dogs, although this toilet could be used by other animals.

### BACKGROUND

There are a variety of disposable pet toilets, such as U.S. Pat. No. 8,522,719 (Feld) and U.S. 5,630,377 (Kumlin). These pet toilets have absorbent medium that must be replaced at periodic intervals.

A more desirable solution, would be to have a flush toilet that would connect to existing household plumping in order to “toilet train” the pet. There are a number of examples of such devices in prior art patents, such as: U.S. Pat. No. 4,231,321 (Cohen); U.S. Pat. No. 5,103,772 (Schmidt); U.S. Pat. No. 5,458,089 (Rymer); U.S. Pat. No. 6,014,946 (Rymer) and U.S. Pat. No. 8,196,547 (Liu et al).

### SUMMARY

There is provided a pet toilet, which includes a water retaining tray having an outlet for connecting the tray to household plumbing. A continuous shelf on which a pet stands during use is contained within the tray. The shelf is spaced above a bottom of the tray and angled with an upper end and a lower end. A flushing system causes a release of water onto the upper end of the shelf. The release of water washes faeces down the shelf and off the lower end of the shelf into the tray, with the faeces exiting the tray through the outlet.

With the pet toilet, as described above, a dog enters the pet toilet from the front and stands on the shelf. After the dog has defecated, the flushing system cleans the shelf and tray so the pet toilet functions much like a human toilet.

Although beneficial results may be obtained through the use of the pet toilet, as described above, male dogs tend to raise their hind legs to urinate. To facilitate this instinctive behaviour, it is preferred that the tray have opposed sidewalls. To clean the opposed sidewalls after urination, it is preferred that manifolds be provided that discharge a supplementary release of water down each of the opposed sidewalls.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front perspective view of the pet toilet.

FIG. 2 is a side elevation view, in section, of the pet toilet of FIG. 1, showing a pet on a shelf of the pet toilet.

FIG. 3 is a side elevation view, in section, of the pet toilet of FIG. 1, showing a flushing occurring after the pet has vacated the pet toilet.

FIG. 4 is a side elevation view, in section, of a variation of the pet toilet with an alternative flushing system.

### DETAILED DESCRIPTION

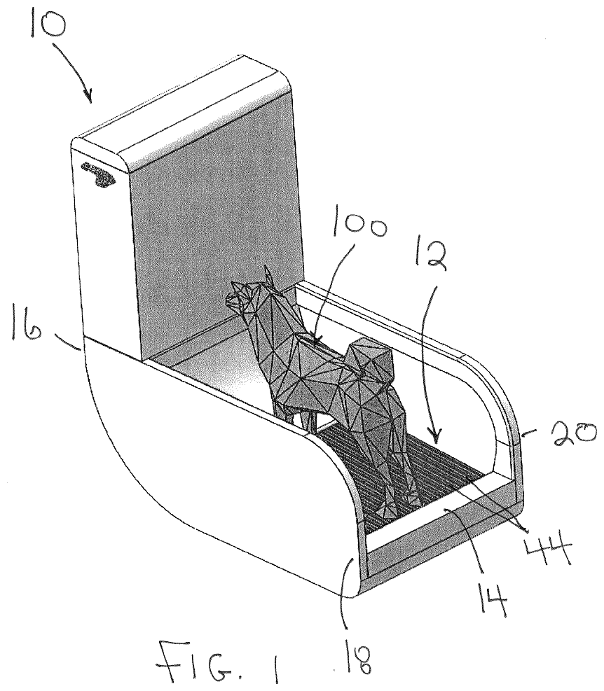

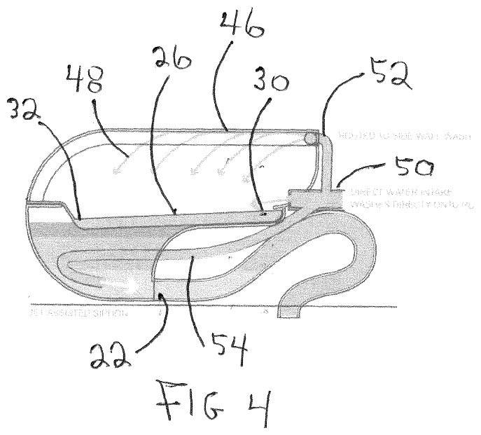

A pet toilet generally identified by reference numeral 10, will now be described with reference to FIG. 1 through FIG. 3. An alternative flushing system for pet toilet 10 will then be described with reference to FIG. 4.

### Structure and Relationship of Parts:

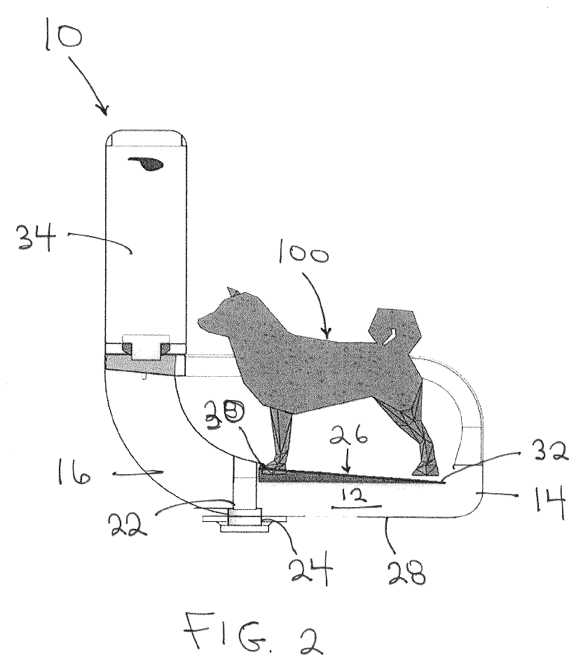

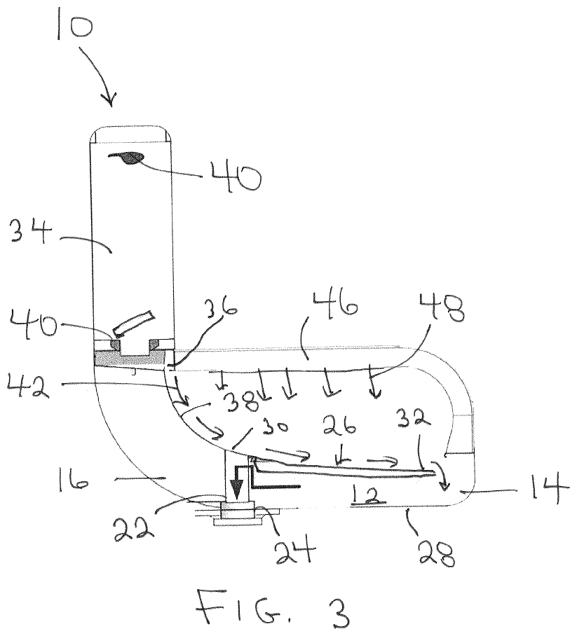

Referring to FIG. 1, pet toilet 10 consists of a water retaining tray 12 having a front 14, a rear 16, opposed sides 18 and 20. Referring to FIG. 2, tray 12 has a bottom 28 and a water outlet 22. Referring to FIG. 3, a plumbing assembly, generally indicated by reference numeral 24, connects outlet 22 of tray 12 to household plumbing (not shown). Referring to FIG. 2, there is a continuous shelf 26, on which a pet 100 stands during use. Shelf 26 is spaced above bottom 28 of tray 12 and angled with an upper end 30 end at rear 16 of tray 12 and a lower end 32 at front 14 of tray 12. A water reservoir 34, which resembles a toilet tank of a flush toilet, is positioned at rear 16 of tray 12.

Referring to FIG. 3, a manifold 36 is positioned at rear 16 of tray 12 above upper end 30 of shelf 26. manifold 36 is connected to water reservoir 34. A spillway 38 extends from manifold 36 to upper end 30 of shelf 26. A flush mechanism 40, such as is used in conventional toilets, causes a release of water 42 from water reservoir 34 through manifold 36.

Referring to FIG. 1, shelf 26 has corrugations 44 which extend from upper end 30 to lower end 32. Corrugations 44 define water flow channels.

Referring to FIG. 3, supplementary manifolds 46 are provided to discharge a supplementary release of water 48 down each of opposed sidewalls 18 and 20.

### Operation:

Referring to FIG. 1, tray 12 of pet toilet 10 is relatively low at front 14 to allow pet 100 easy access. Referring to FIG. 2, pet 100 must be trained to step onto shelf 26 of pet toilet 10 to defecate. Referring to FIG. 3, once pet 100 has exited pet toilet 10, the owner activates flush mechanism 40. Flush mechanism 40 causes a release of water 42 from water reservoir 34 through manifold 36. Release of water 42 from manifold 26 flows down spillway 38 onto upper end 30 of shelf 26. Release of water 42 washes faeces down shelf 26 and off lower end 32 of shelf 26 into tray 12. Corrugations 44 define water flow channels and provide for a more even flow of water across shelf 26. Urine is washed from opposed sidewalls 18 and 20 by supplementary release of water 48 from supplementary manifolds 46. Faeces and urine washed into tray 12, exit tray 12 through outlet 22 and plumbing assembly 24 in the same manner as any other flush toilet.

### Cautionary Warning

Upon building the proto-type of pet toilet 10, while pet toilet 10 functioned, there was dissatisfaction with the flushing of faeces. Referring to FIG. 3, at times, the release of water 42 from manifold 26 flowing down spillway 38 onto upper end 30 of shelf 26 was insufficient to wash faeces down shelf 26 and off lower end 32 of shelf 26 into tray 12. At times, faeces washed from shelf 26 into tray 12, did not immediately exit tray 12 through outlet 22.

Referring to FIG. 4, these problems were addressed through a modified flushing system. With this alternative flushing system, a water line 50 discharges a volume of water under pressure directly onto upper end 30 of shelf 26. This generates both a greater volume of water and greater force and more effectively washes faeces off lower end 32 of shelf 26 into tray 12. Water line 50 has an upper branch line 52 and a lower branch line 54. Lower branch line 54, extends into tray 12 and serves as a jet assisted siphon to create a jet of fluid which urges faeces in tray 12 through outlet 22. Upper branch line 52 extends to supplementary manifolds 46 which discharge a supplementary release of water 48 down each of opposed sidewalls 18 and 20, as has previously been described.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A pet toilet, comprising:
a water retaining tray having an outlet for connecting the tray to household plumbing;
a continuous shelf on which a pet stands during use contained within the tray, the shelf being spaced above a bottom of the tray and angled with an upper end and a lower end; and
a flushing system that causes a release of water onto the upper end of the shelf, such that the release of water washes faeces down the shelf and off the lower end of the shelf into the tray, with the faeces exiting the tray through the outlet.

2. The pet toilet of claim 1, wherein the flushing system comprises a water reservoir with a manifold positioned above the upper end of the shelf supplied with water from the water reservoir.

3. The pet toilet of claim 1, wherein the shelf has corrugations which extend from the upper end to the lower end, the corrugations defining water flow channels.

4. The pet toilet of claim 2, wherein a spillway extends from the manifold to the upper end of the shelf.

5. The pet toilet of claim 2, wherein the tray has opposed sidewalls, with supplementary manifolds discharging a supplementary release of water down each of the opposed sidewalls.

6. The pet toilet of claim 1, wherein the flushing system comprises a water line that discharges a volume of water under pressure directly onto the upper end of the shelf.

7. The pet toilet of claim 6, wherein the flushing system comprises a lower branch line that extends into the tray and generates a jet of fluid which urges faeces in the tray through the outlet.
